(19) United States
(12) Patent Application Publication
(10) Pub. No.: US 2025/0372842 A1
(43) Pub. Date: Dec. 4, 2025

(54) CYLINDRICAL BATTERY

(71) Applicant: MURATA MANUFACTURING CO., LTD., Kyoto (JP)

(72) Inventors: Kensuke FUJIWARA, Kyoto (JP); Yoshiichi HORIKOSHI, Kyoto (JP); Yusuke TANJI, Kyoto (JP)

(21) Appl. No.: 19/173,417

(22) Filed: Apr. 8, 2025

(30) Foreign Application Priority Data
Jun. 1, 2024 (JP) 2024-096857

(51) Int. Cl. H01M 50/578; H01M 50/152

(52) U.S. Cl. CPC H01M 50/578; H01M 50/152; H01M 2200/20

(57) ABSTRACT

A cylindrical battery is provided and including a top cover, and a safety valve, wherein the safety valve has a safety cover and a stripper disk positioned inward in a battery axial direction from the safety cover, and a predetermined portion of the safety cover positioned between a portion where the safety cover and the top cover are in contact with each other and a portion where the safety cover and the stripper disk are in contact with each other is an inclined portion inclined inward in a battery axial direction with respect to a contact surface where the safety cover and the top cover are in contact with each other.

### CROSS REFERENCE TO RELATED APPLICATIONS

The present application claims priority to Japanese Patent Application No. 2024-096857, filed on Jun. 1, 2024, the entire contents of which are incorporated herein by reference.

### BACKGROUND

The present disclosure relates to a cylindrical battery.

Batteries such as cylindrical batteries can extract energy due to chemical change or the like as electric energy, and are used for various applications. For example, cylindrical batteries are used in mobile devices such as notebook computers.

Cylindrical batteries are required to have safety. In order to achieve such safety, there is a cylindrical battery including a safety valve capable of current interruption in an abnormal state. This cylindrical battery includes a top cover and a safety valve, wherein the safety valve has a safety cover with a stepped structure and a stripper disk positioned inward in the battery axial direction from the safety cover. The safety cover has the stepped structure, and thus deformation of the safety cover due to an increase in internal pressure at the time of battery abnormality can be controlled.

### SUMMARY

The present disclosure relates to a cylindrical battery.

For the conventional cylindrical battery, the inventor of the present application has found that there is a matter that can be improved. Specifically, when the safety cover has only a stepped structure, the central portion of the safety cover is concerned to be deformed at a low pressure in a case where the battery is not abnormal. Therefore, the displacement of the safety cover increases under such low pressure, which poses a risk of unintended current interruption. In addition, when the safety cover only has a stepped structure, the displacement of the safety cover for current interruption is small, and the safety cover and the stripper disk come into contact with each other after the current interruption at the time of a battery abnormality, which posed a risk of reconduction of the current.

The present disclosure has been made in view of the above problem. The present disclosure, in an embodiment, is to provide a cylindrical battery including a safety valve capable of suitably suppressing unintended current interruption and reconduction after current interruption at the time of battery abnormality.

In an embodiment of the present disclosure, there is provided a cylindrical battery including:
a top cover; and
a safety valve,
wherein the safety valve has a safety cover and a stripper disk positioned inward in the battery axial direction from the safety cover, and
a predetermined portion of the safety cover positioned between a portion where the safety cover and the top cover are in contact with each other and a portion where the safety cover and the stripper disk are in contact with each other is an inclined portion inclined inward in a battery axial direction with respect to a contact surface where the safety cover and the top cover are in contact with each other.

The cylindrical battery according to the present disclosure can suitably suppress unintended current interruption and reconduction after current interruption at the time of battery abnormality.

### BRIEF DESCRIPTION OF THE FIGURES

FIG. 1 is a schematic perspective view showing the appearance of a cylindrical battery;

FIG. 2 is a schematic view showing an internal configuration of a cylindrical battery;

FIG. 3 is a schematic perspective view showing constituent members and related members of a safety valve of a cylindrical battery in a developed state;

FIG. 4 is a schematic sectional view showing a configuration of a safety valve of a cylindrical battery according to an embodiment of the present disclosure;

FIG. 5 is a graph showing a relationship between a displacement of the safety cover and a pressure applied to the safety cover due to a difference in presence or absence of an inclined portion of the safety cover;

FIG. 6 is a schematic sectional view for describing a displacement of the safety cover;

FIG. 7 is a schematic sectional view for describing an action mechanism when pressure is applied to an inclined portion of the safety cover;

FIG. 8A is a schematic sectional view showing mode pattern 1 of the stepped portion in the thickness direction of the safety cover;

FIG. 8B is a schematic sectional view showing mode pattern 2 of the stepped portion in the thickness direction of the safety cover;

FIG. 8C is a schematic sectional view showing mode pattern 3 of the stepped portion in the thickness direction of the safety cover;

FIG. 9 is a table showing measurement results of Examples and Comparative Examples of the present application;

FIG. 10 is a graph showing a relationship between a pressure on the safety cover and a displacement of the safety cover due to a difference in thickness of a thin portion of a first stepped portion of the safety cover;

FIG. 11 is a graph showing a relationship between a pressure on the safety cover and a displacement of the safety cover due to a difference in a shape of the first stepped portion of the safety cover; and

FIG. 12 is a graph showing a relationship between a pressure on the safety cover and a displacement of the safety cover due to a difference in a shape of a second stepped portion of the safety cover.

### DETAILED DESCRIPTION

Hereinafter, the cylindrical battery according to an embodiment of the present disclosure will be described in further detail including with reference to the drawings.

The cylindrical “battery” in the present specification includes not only a so-called “secondary battery” but also a “primary battery”, which is capable of only discharging. That is, the “battery” in the present specification may be a “secondary battery” that can be repeatedly charged and discharged, or a “primary battery” that is substantially only discharged. The “secondary battery” is not excessively bound by the name, and may include an “electric storage device”, for example.

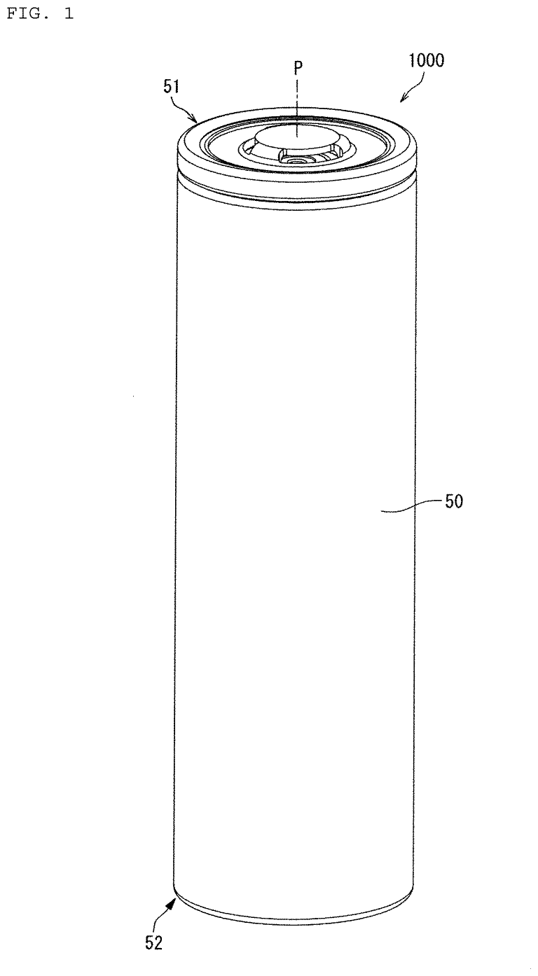

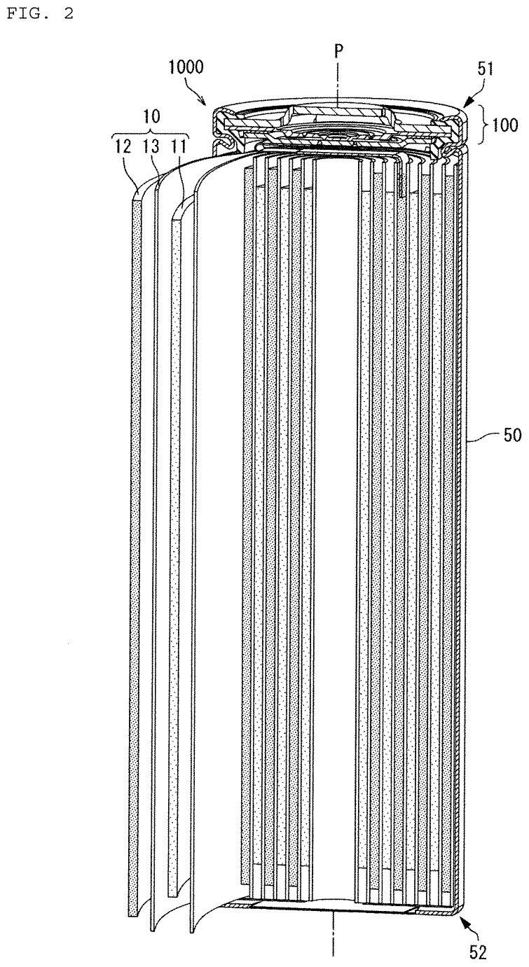

Hereinafter, for convenience of description, the cylindrical battery according to the present disclosure will be described mainly by taking the secondary battery as an example. FIG. 1 is a schematic perspective view showing the appearance of a cylindrical battery. FIG. 2 is a schematic view showing an internal configuration of a cylindrical battery. FIG. 3 is a schematic perspective view showing constituent members and related members of a safety valve of a cylindrical battery in a developed state.

A secondary battery includes an electrode assembly including an electrode-constituting layer including a positive electrode, a negative electrode, and a separator. The secondary battery may have a wound structure (hereinafter, also referred to as “wound electrode body” or “wound structure body”) in which such an electrode-constituting layer is wound in a roll shape. As shown in the drawing, the electrode assembly 10 is housed inside a cylindrical battery can 50. In the exemplary aspect shown in FIG. 2, an electrode assembly 10 has a configuration in which a positive electrode 11, a negative electrode 12, and a separator 13 disposed between the positive electrode and the negative electrode are wound. For the secondary battery 1000, such an electrode assembly 10 is enclosed together with an electrolyte (for example, a non-aqueous electrolyte) in the cylindrical battery can 50.

The positive electrode 11 includes at least a positive electrode material layer and a positive electrode current collector. In the positive electrode, the positive electrode material layer is provided on at least one surface of the positive electrode current collector. The positive electrode material layer contains a positive electrode active material as an electrode active material. For example, for each of a plurality of positive electrodes in the electrode assembly, the positive electrode material layer may be provided on both surfaces of the positive electrode current collector, or may be provided only on one surface of the positive electrode current collector.

The negative electrode 12 includes at least a negative electrode material layer and a negative electrode current collector. In the negative electrode, the negative electrode material layer is provided on at least one surface of the negative electrode current collector. The negative electrode material layer contains a negative electrode active material as an electrode active material. For example, for each of a plurality of negative electrodes in the electrode assembly, the negative electrode material layer may be provided on both surfaces of the negative electrode current collector, or may be provided only on one surface of the negative electrode current collector.

The electrode active materials included in the positive electrode 11 and the negative electrode 12, that is, the positive electrode active material and the negative electrode active material are substances directly involved in the transfer of electrons in the secondary battery, and are main substances of the positive and negative electrodes, which are responsible for charging and discharging, that is, a battery reaction. More specifically, ions are brought into the electrolyte due to the “positive electrode active material contained in the positive electrode material layer” and the “negative electrode active material contained in the negative electrode material layer”, and the ions move between the positive electrode and the negative electrode to transfer electrons, and thus charging and discharging is performed. The positive electrode material layer and the negative electrode material layer may be layers particularly capable of occluding and releasing lithium ions. More specifically, the secondary battery according to the present disclosure may be a non-aqueous electrolyte secondary battery in which lithium ions move between the positive electrode and the negative electrode with a non-aqueous electrolyte interposed therebetween, thereby charging and discharging the battery. In a case where lithium ions are involved in charge and discharge, the secondary battery according to the present disclosure corresponds to a so-called “lithium ion battery”, and includes electrodes capable of occluding and releasing lithium ions as a positive electrode and a negative electrode, and preferably includes layers capable of occluding and releasing lithium ions.

In view of a lithium ion battery, the positive electrode active material may be a material that contributes to occlusion and release of lithium ions. That is, the positive electrode layer may include any one type or two or more types among positive electrode materials capable of occluding and releasing lithium. From such a viewpoint, the positive electrode active material may be, for example, a lithium- containing compound. The lithium-containing compound is not particularly limited in the type thereof, but may be, for example, a lithium-containing composite oxide, a lithium-containing phosphate compound, or the like. This is because a high energy density can be easily obtained.

The lithium-containing composite oxide is a generic name of oxides including lithium and one or two or more of other elements (elements other than lithium) as constituent elements, and may have, for example, one of crystal structures such as a layered rock-salt type crystal structure and a spinel type crystal structure. The lithium-containing phosphate compound is a generic name of phosphate compounds that include lithium and one or two or more of other elements as constituent elements, and may have, for example, a crystal structure such as an olivine type crystal structure. The type of the other elements is not particularly limited as long as the element is any one or two or more of any elements. Among them, as the other elements, one or two or more of elements belonging to Groups 2 to 15 in the long-period periodic table is preferable. More specific examples thereof include nickel (Ni), cobalt (Co), manganese (Mn), and iron (Fe). This is because a high voltage can be easily obtained.

The positive electrode material layer may include a binder. In addition, the positive electrode material layer may include a positive electrode conductive agent in order to facilitate electron transfer promoting the battery reaction. The positive electrode binder may include, for example, any one or one or more types of synthetic rubbers and polymer compounds. The synthetic rubber is, for example, styrene-butadiene-based rubber, fluorine-based rubber, and ethylene propylene diene. The polymer compound is, for example, polyvinylidene fluoride or polyimide. The positive electrode conductive agent may include, for example, any one or two or more of carbon materials. This carbon material may be, for example, graphite, carbon black, acetylene black, and ketjen black. However, the positive electrode conductive agent may be a metal material, a conductive polymer, and the like, as long as it is a material exhibiting conductivity.

Similarly, the negative electrode active material of the negative electrode material layer may be a material that contributes to occlusion and release of lithium ions. That is, the negative electrode layer may include any one or two or more among negative electrode materials capable of occluding and releasing lithium. From such a viewpoint, the negative electrode active material may be, for example, various carbon materials, metal-based materials, and other materials.

In a case of using the carbon material as the negative electrode active material, the crystal structure shows a very small change when lithium is occluded and when lithium is released, and thus a high energy density can be easily and stably obtained. In addition, the carbon material also functions as a negative electrode conductive agent, and thus the negative electrode layer easily has an improved conductivity.

Specific examples of the carbon material include graphitizable carbon, non-graphitizable carbon, and graphite. More specifically, the carbon material may be, for example, pyrolytic carbons, cokes, glassy carbon fiber, organic polymer compound fired body, activated carbon, or carbon blacks. The cokes may include pitch coke, needle coke, and petroleum coke. The organic polymer compound fired body is, for example, a material obtained by firing (carbonizing) a polymer compound such as phenol resin and furan resin at an appropriate temperature. In addition, the carbon material may be low crystalline carbon subjected to a heat treatment at a temperature of about 1000° C. or less, or may be amorphous carbon. The shape of the carbon material is not particularly limited, and may be at least one of a fibrous shape, a spherical shape, a granular shape, and a scaly shape.

The “metal-based material” used as the negative electrode active material is a generic name of materials including any one or two or more among metal elements and metalloid elements as constituent elements. When the carbon material is used as the negative electrode active material, a high energy density can be easily obtained. The metal-based material may be a single metal, an alloy, a compound, two or more of these, or a material at least a part of which has one or one or more of these phases.

Specific examples of the metal element and the metalloid element include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc, hafnium (Hf), zirconium, yttrium (Y), palladium (Pd), and/or platinum (Pt).

The negative electrode material layer may include a binder. Further, a negative electrode conductive agent may be included in the negative electrode material layer to facilitate the transfer of electrons promoting the battery reaction. The binder that can be included in the negative electrode material layer is not particularly limited, and examples thereof include at least one selected from the group consisting of styrene-butadiene rubber, polyacrylic acid, polyvinylidene fluoride, polyimide-based resins, and polyamideimide-based resins. The negative electrode conductive agent that can be included in the negative electrode material layer is not particularly limited, but examples thereof include at least one selected from carbon blacks such as thermal black, furnace black, channel black, ketjen black, and acetylene black, graphite, carbon fibers such as carbon nanotube and vapor-grown carbon fiber, metal powders such as copper, nickel, aluminum, and silver, and polyphenylene derivatives. The negative electrode material layer may include a component derived from a thickener component (for example, a carboxymethyl cellulose) used during battery production.

The positive electrode current collector and the negative electrode current collector used in the positive electrode 11 and the negative electrode 12 are members that contribute to collecting and supplying electrons generated in the electrode active material due to the battery reaction. Such an electrode current collector may be a sheet-shaped metal member. In addition, the electrode current collector may have a single layer or multiple layers. Further, the electrode current collector may have a porous or perforated form. For example, the current collector may be a metal foil, a punching metal, a net, an expanded metal, or the like. The positive electrode current collector that is used for the positive electrode may be composed of, for example, a metal foil including at least one selected from the group consisting of aluminum, nickel, stainless steel, and the like. On the other hand, the negative electrode current collector that is used for the negative electrode may be composed of, for example, a metal foil including at least one selected from the group consisting of copper, aluminum, nickel, stainless steel, and the like.

The separator 13 is a member provided from the viewpoints such as preventing a short circuit due to contact between the positive and negative electrodes and holding the electrolyte. In other words, the separator is a member that separates the positive electrode and the negative electrode, and allows ions (for example, lithium ions) to pass while preventing a short circuit of a current due to contact between both electrodes. For example, the separator may be a porous or microporous insulating member, which may have a film form due to a small thickness thereof. The separator 13 may be, for example, any one or two or more of porous membranes such as synthetic resin and/or ceramic, and may be a laminated membrane of two or more porous membranes.

The electrolyte may typically be an electrolytic solution. The electrolytic solution includes a solvent and an electrolyte salt. The electrolytic solution may further include any one or two or more of other materials such as additives. In a preferred aspect, the separator may be impregnated with an electrolytic solution, and the positive electrode and/or the negative electrode may also be impregnated with an electrolytic solution.

The solvent may include any one or two or more of non-aqueous solvents such as organic solvents. The electrolytic solution including a non-aqueous solvent can be a so-called non-aqueous electrolytic solution. Examples of the non-aqueous solvent include a cyclic carbonate ester, a chain carbonate ester, a lactone, a chain carboxylate ester, and/or a nitrile (for example, mononitrile).

The cylindrical battery can 50 corresponds to a member enclosing an electrode assembly 10 in which electrode-constituting layers including the positive electrode 11, the negative electrode 12, and the separator 13 are stacked as a battery package. The battery can 50 may have, for example, a hollow structure in which one end portion is closed and the other end portion is opened (opened as an open end portion). The battery can 50 is not particularly limited, but may be a metal can containing any one or two or more of metal materials such as iron, aluminum, stainless steel, and alloys thereof. For example, any one or two or more of metal materials such as nickel may be plated on the surface of the battery can 50.

In addition, a safety valve 100 can be provided at the opening end 51 of the cylindrical battery can 50. Although it is merely an example, the safety valve 100 can be provided at the opening end of the battery can 50 with a gasket interposed therebetween (that is, the safety valve 100 of the battery may be provided together with a caulking mechanism).

A configuration of the safety valve 100 will be described below (refer to FIG. 3).

The safety valve 100 contributes to a battery terminal (that is, one of the positive electrode terminal and the negative electrode terminal as the external terminal of the battery) and includes a mechanism that can be displaced in response to an excessive internal pressure of the battery. The safety valve 100 includes at least a safety cover 110, a stripper disk 130, and an insulating member 120 positioned therebetween. In addition, in the safety valve 100, a top cover 150 can be further provided outward in the battery axial direction with respect to the safety cover 110. Herein, the outward in the battery axial direction refers to the side opposite to the side on which the electrode assembly 10 is positioned with reference to the position of the safety cover 110 in the battery axial direction.

The safety cover 110 is positioned relatively outward in the battery axial direction, while the stripper disk 130 is positioned relatively inward in the battery axial direction, and they are electrically connected to each other. Preferably, the safety cover 110 and the stripper disk 130 are connected to each other so as to straddle the insulating member 120.

In the present specification, the “battery axis” refers to an axis P extending in a direction perpendicular to an end surface or bottom surface of the battery can so as to pass through the center of the battery can corresponding to the battery package (refer to FIGS. 1 to 3). For example, the battery axis refers to an axis that passes through the center of the battery can 50 and extends in a direction orthogonal to the radial direction of the bottom surface of the battery can. In addition, the battery axis can be an axis extending between both terminals so as to pass through the center of both terminals. From the above, the “battery axial direction” refers to a direction in which the battery axis extends.

Each of the safety cover 110 and the stripper disk 130 may be a disk-shaped member. Each of the safety cover 110 and the stripper disk 130 may have, for example, a shape extending in the battery width direction (a direction corresponding to the radial direction of the cylindrical battery) as a whole. That is, each of the safety cover 110 and the stripper disk 130 may have a form extending as a whole in a direction orthogonal to the battery axial direction. The insulating member 120 has an opening portion or a hollow portion in an inner or central region thereof, and may have a plate shape (for example, a flat plate shape) or a flat shape as a whole.

The safety cover 110, the stripper disk 130, and the insulating member 120 having the above-described configuration are disposed so as to be directly stacked on each other, and the safety valve is provided. The safety cover 110 is displaced by receiving the battery internal pressure at the time of abnormality, thereby contributing to the function of the safety valve. Specifically, when the stripper disk 130 is broken starting from a groove provided in the stripper disk, the safety cover 110 bends together with the broken stripper disk 130, and current interruption is performed through the displacement. For those having a configuration other than the safety cover 110, the stripper disk 130, and the insulating member 120, the safety valve 100 can also be included in the application range of the present disclosure.

The safety cover 110 provided as a safety cover mainly corresponds to a displaceable member that can close the opening end 51 of the battery can 50 and can be displaceable and/or openable in response to an increase in the internal pressure of the battery can. The internal pressure of the battery can increases due to a side reaction such as a decomposition reaction of the electrolytic solution, for example. That is, a gas such as carbon dioxide is generated inside the battery can when a side reaction such as a decomposition reaction of the electrolytic solution occurs, and thus the internal pressure of the battery can undesirably increases according to an increase of the generation amount of the gas.

The safety cover 110 may have, for example, a plurality of stepped portions 111 and 112 as ideal shapes for preventing unintended blocking and reconduction between the portion X where the safety cover 110 and the top cover 150 are in contact with each other and the portion Y where the safety cover 110 and the stripper disk 130 are in contact with each other. Specifically, the safety cover 110 can have a first stepped portion 111 positioned on the outer peripheral side and a second stepped portion 112 positioned on the inner peripheral side. A first groove 118 contributing to cleavage of the safety cover 110 is formed between the first stepped portion 111 and the second stepped portion 112. Herein, the inner peripheral side and the outer peripheral side respectively refer those corresponding to the inward side and the outward side along the radial direction of the battery can 50 with the battery axis P (axis passing through the center of the battery can 50 and extending in a direction orthogonal to the radial direction of the bottom surface of the battery can) as a base point.

The safety cover 110 may be a metal member. For example, the safety cover 110 may include any one of, or two or more of metal materials such as aluminum (for example, aluminum metal or aluminum alloy, such as A1050, A3203, and/or A5052), iron (Fe), titanium (Ti), platinum (Pt), and gold (Au). In other words, it can be said that the safety cover 110 may be a member made of such a conductive material.

A planar shape of the safety cover 110, particularly an outer ring contour shape in a plan view (hereinafter, also referred to as an “outer contour shape in a plan view”) is not particularly limited, but may be, for example, a circular shape, a polygonal shape, or another shape. The circular shape is, for example, a true circle (perfect circle), an ellipse, a substantial circle, or the like. The substantial circle is, for example, a generic name of a some or all distorted shape of a true circle. The polygons are, for example, triangles, squares, pentagons and hexagons. The other shapes are, for example, shapes other than a circle whose contour is formed only by a curve, shapes in which two or more types of polygons are combined, and shapes in which one or more types of circles and one or more types of polygons are combined. Such a definition of “circular” and the like is the same hereinafter. In the shown exemplary aspect, the outer contour shape of the safety cover 110 in a plan view is circular.

The safety cover 110 may have, for example, a plate shape as a whole. That is, the safety cover 110 may have a form extending as a whole in a direction orthogonal to the battery axial direction. Although it is merely an example, the thickness of the safety cover 110 may be substantially constant except for local regions such as a stepped portion, a thin portion, and a groove provided on the safety cover.

The insulating member 120 is interposed between the safety cover 110 and the stripper disk 130, and corresponds to a member that enables at least the safety cover 110 and the stripper disk 130 to be connected to each other. The insulating member 120 may have an annular shape as a whole. That is, the shape of the insulating member 120 in a plan view may be a loop shape, a ring shape, or the like. Due to such a loop shape or ring shape, the inner region of the insulating member 120 forms a hollow portion or an opening region 120C (that is, “opening portion” described later).

An outer contour shape of such an insulating member 120 in a plan view is not particularly limited, but may be the same as the outer contour shape of the safety cover 110 in a plan view, and may be, for example, a circular shape. The loop shape or ring shape of the insulating member 120 may be provided as the whole member (refer to FIG. 3), or the loop shape or ring shape may be locally divided. Further, the insulating member 120 may have, for example, a flat plate shape as a whole. That is, the insulating member 120 may have a form extending on the same plane as a whole. Although it is merely an example, the insulating member 120 may have a substantially constant thickness between the safety cover 110 and the stripper disk 130. Preferably, the insulating member 120 may be interposed between the safety cover 110 and the stripper disk 130 such that the opening region 120C of the insulating member 120 is positioned in the region including the battery axis.

The insulating member 120 has an insulating property, and thus electrical conduction via the insulating member 120 is preferably prevented. The term “insulation” as used herein may have an electrical resistivity, that is, the insulating property of a general insulator, and therefore may have an electrical resistivity of the general insulator, and may have a resistivity of at least 1.0×10⁵ Ω·m or more, preferably 1.0×10⁶ Ω·m or more, and more preferably 1.0×10⁷ Ω·m or more (room temperature: 20° C.) although it is merely an example.

The insulating member 120 may contribute to insulation and may not necessarily be bonded thereto. On the other hand, for example, when bonded, the insulating member 120 may be interposed between the safety cover 110 and the stripper disk 130 as an adhesive layer. The insulating member 120 may be interposed between the safety cover 110 and the stripper disk 130 such that the opening region 120C of the insulating member 120 is positioned in the region including the battery axis.

The insulating member 120 is preferably composed of a resin material. That is, the main component of the insulating member may be a resin material, or the insulating member may be configured to include at least a resin in the material of the member. When composed of such a resin material, the insulating member 120 more preferably contributes to the adhesiveness between the safety cover 110 and the stripper disk 130 while securing the insulating property.

When the insulating member 120 is composed of a resin material, for example, the insulating member 120 may be composed of a thermosetting resin, a thermoplastic resin, and/or a UV curable resin. When a viewpoint of connectivity is particularly emphasized, the insulating member 120 may be a member including a resin adhesive having the insulating property. Examples of such a resin adhesive include an acrylic-based resin adhesive such as acrylic acid ester copolymers, a rubber-based resin adhesive such as natural rubber, a silicone-based resin adhesive such as silicone rubber, a urethane-based resin adhesive such as a urethane resin, an x-olefin-based resin adhesive, an ether-based resin adhesive, an ethylene-vinyl acetate resin-based resin adhesive, an epoxy resin-based resin adhesive, a vinyl chloride resin-based resin adhesive, a chloroprene rubber-based resin adhesive, a cyanoacrylate-based resin adhesive, an aqueous polymer-isocyanate-based resin adhesive, a styrene-butadiene rubber-based resin adhesive, a nitrile rubber-based resin adhesive, a nitrocellulose-based resin adhesive, a reactive hot-melt-based resin adhesive, a phenol resin-based resin adhesive, a modified silicone-based resin adhesive, a polyamide resin-based resin adhesive, a polyimide-based resin adhesive, a polyurethane resin-based resin adhesive, a polyolefin resin-based resin adhesive, a polyvinyl acetate resin-based resin adhesive, a polystyrene resin solvent-based resin adhesive, a polyvinyl alcohol-based resin adhesive, a polyvinyl pyrrolidone resin-based resin adhesive, a polyvinyl butyral resin-based resin adhesive, a polybenzimidazole-based resin adhesive, a polymethacrylate resin-based resin adhesive, a melamine resin-based resin adhesive, a urea resin-based resin adhesive, and/or a resorcinol-based resin adhesive.

In addition, the stripper disk 130 is disposed relatively inside the battery with respect to the safety cover 110 with the insulating member 120 interposed therebetween, and corresponds to a member that contributes to current interruption at the time of abnormality and/or, for example, passage or release of gas inside the battery can.

The stripper disk 130 may be a metal member. For example, the stripper disk 130 may include any one of, or two or more of metal materials such as aluminum (for example, aluminum metal or aluminum alloy, such as A1050, A3203, and/or A5052), iron (Fe), titanium (Ti), platinum (Pt), and gold (Au). In other words, the stripper disk 130 may be a member composed of such a conductive material. The material of the stripper disk 130 may be the same as or different from the material of the safety cover 110. The outer contour shape of the stripper disk 130 in plan view is not particularly limited, but is, for example, similar to the outer contour shape of the safety cover 110 in plan view. In the shown exemplary aspect, the outer contour shape of the stripper disk 130 in plan view is circular.

The stripper disk 130 may have a shape extending in the battery width direction, for example, a disk shape as a whole. That is, the stripper disk 130 may have a form extending as a whole in a direction orthogonal to the battery axial direction. For example, the stripper disk may have a substantially constant thickness dimension.

The stripper disk 130 may be provided with a plurality of opening portions 130K. The plurality of opening portions 130K mainly correspond to ventilation ports that contribute to passage or release of gas inside the battery can. For example, the plurality of opening portions 130K may be provided in a region on the outer peripheral side of the central region 130C.

In the safety valve, the safety cover 110 and the stripper disk 130 are integrated as a whole by interposing the insulating member 120 therebetween, but the safety cover 110 and the stripper disk 130 may be electrically connected to each other in a central region thereof. For example, the safety cover 110 may be directly connected to the central region 130C of the stripper disk 130 so as to straddle the insulating member 120.

In addition, the top cover 150 is electrically connected to the safety cover 110. The top cover corresponds to a battery cover provided to cover the opening end of the battery can together with other components of the safety valve. In other words, the safety cover 110 is connected to the top cover 150 forming an external terminal of the battery. As shown in FIG. 3, the top cover 150 has a convex portion 150A raised outward in the battery axial direction (for example, raised so as to be curved). In particular, the convex portion 150A is provided in the central region of the top cover.

The convex portion 150A of the top cover 150 has a form in which an annular region of the top cover is at least partly raised (for example, raised so as to be curved), and a shape in which a central region or an inner region of the top cover is raised or protruded to the outside of the battery. Therefore, the top cover 150 includes at least one bent portion 150C extending from the flat plate portion 150B toward the outside of the battery, and the bent portions 150C are separated from each other (refer to FIG. 3). An opening portion 150D is provided in the top cover 150 due to the separation of the bent portion. Such a top cover 150 can suitably function as a terminal of the battery. For example, the top cover 150 functions as a positive electrode terminal of the battery, and the battery can functions as a negative electrode terminal. In such a case, the top cover and the battery can may be insulated from each other. For example, the top cover may be insulated from the battery can by interposing an insulating material between the top cover and the battery can.

The opening portion 150D of the top cover 150 can act as a discharge hole for discharging a gas generated inside the battery to the outside of the battery. The material of the top cover 150 may be metal. For example, the top cover 150 may be composed of a conductive material such as steel such as iron (Fe) and SPCC, stainless steel (SUS) such as SUS430 and SUS304, nickel (Ni), aluminum (Al), and/or titanium (Ti).

A conductive member 15 extending from the electrode assembly 10 is connected to the safety valve 100. The conductive member 15 is electrically connected to the electrode assembly 10 (in particular, one of the positive electrode and the negative electrode), and contributes to electrical connection between the electrode assembly 10 and the safety valve (in particular, the stripper disk 130). In the safety valve, the stripper disk 130 is electrically connected to the safety cover 110 with the central region 130C interposed therebetween, and the safety cover 110 is connected to the top cover 150 forming an external terminal of the battery. Therefore, the electrode assembly 10 such as the wound structure is electrically connected to the battery external terminal with the conductive member 15 interposed therebetween.

In such a configuration, when the internal pressure of the battery can 50 abnormally increases, the stripper disk 130 can be broken starting from the second groove 135 formed in the central region, and the subsequent inconvenient current can be interrupted. For example, when a gas is generated due to a side reaction such as a decomposition reaction of the electrolytic solution inside the battery can 50, the gas is accumulated in the battery can 50, and thus the internal pressure of the battery can 50 increases. When the internal pressure of the battery can 50 continues to increase, the safety cover 110 is affected by the increase in the internal pressure. When the internal pressure of the battery can 50 exceeds a certain predetermined pressure, the stripper disk 130 is pulled by the safety cover 110, and the stripper disk 130 is broken starting from the second groove 135. This is because the stripper disk 130 and the safety cover 110 are connected to each other in the central region thereof, and particularly the central region of the stripper disk 130 is pulled outward in the battery axial direction due to the force received from the safety cover 110 that tries to be displaced by receiving the internal pressure.

That is, when the tensile force exceeds a certain limit, the stripper disk 130 is broken starting from the second groove 135 positioned around the central region. When such breakage of the stripper disk 130 occurs, the safety cover 110 is electrically separated from a non-central region (in particular, a non-central region of a peripheral edge portion to which conductive members, such as tabs and leads, extending from the electrode assembly are still connected) of the stripper disk 130. Specifically, when the stripper disk 130 is broken starting from the second groove 135 provided in the stripper disk, the safety cover 110 bends together with the broken stripper disk 130, and current interruption is performed through the displacement. Therefore, the electrical connection between the top cover 150 and the electrode assembly 10 is disconnected, and the path of the current flowing between the electrode assembly 10 and the top cover 150 is interrupted. In this manner, the current interruption can be achieved at the time of abnormality such as an increase in internal pressure.

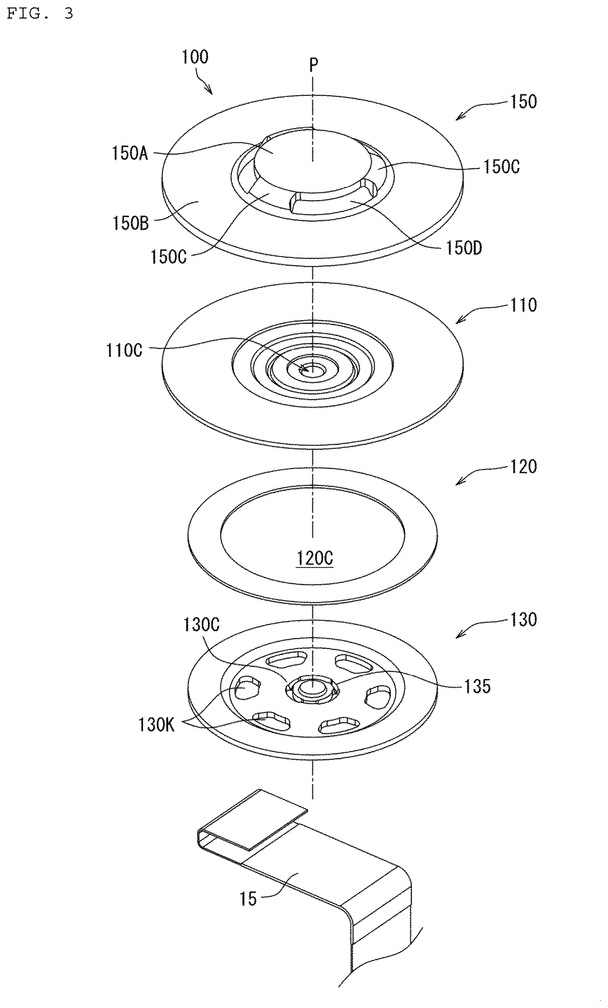

Herein, the present disclosure has the following technical features according to an embodiment. Specifically, in the safety valve 100, the predetermined portion 114 of the safety cover 110 positioned between the portion X where the safety cover 110 and the top cover 150 are in contact with each other and the portion Y where the safety cover 110 and the stripper disk 130 are in contact with each other is an inclined portion 115 inclined inward in the battery axial direction with respect to the contact surface X1 where the safety cover 110 and the top cover 150 are in contact with each other (refer to FIG. 4). Specifically, such an inclined portion 115 can be positioned between the first stepped portion 111 and the second stepped portion 112 of the safety cover 110 described above.

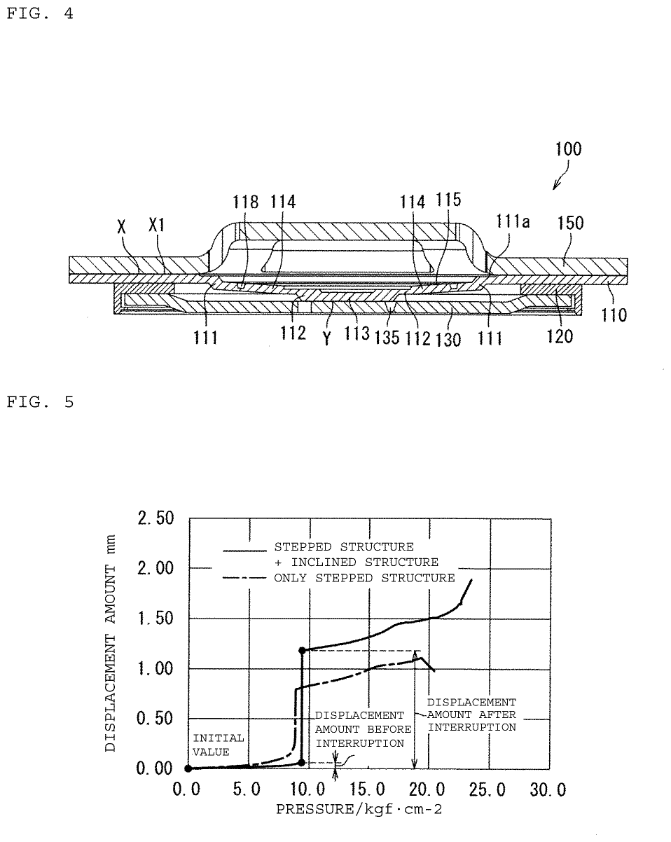

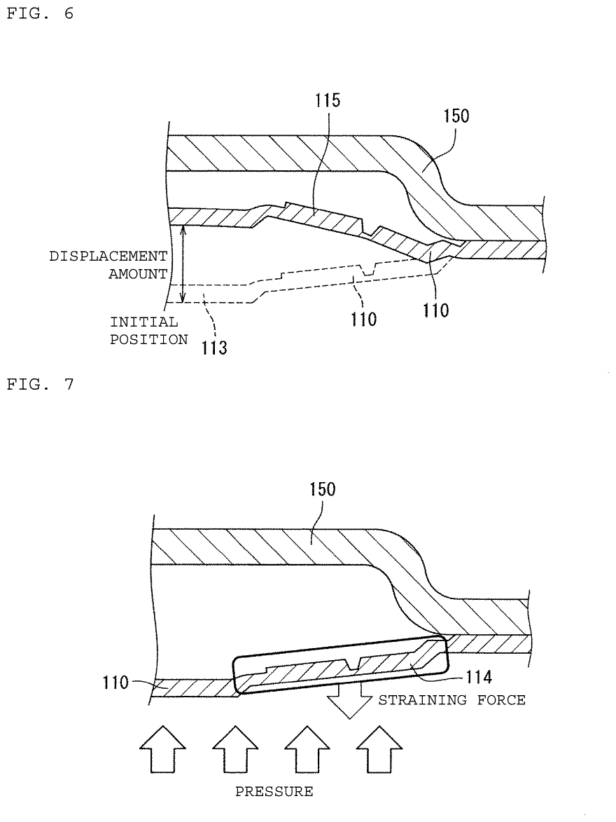

According to such a configuration, the total length in the predetermined width region of the safety cover 110 can be made large as compared with the case where the inclined portion 115 is not provided. Thus, when the safety cover 110 is subjected to a low pressure (specifically, the pressure is lower than the internal pressure value at which the safety valve 100 is desired to be disconnected, in other words, the pressure at which the safety valve 100 is not desired to be disconnected) and the central region 113 (specifically, a central convex portion protruding inward in the battery axial direction in the central region 113) of the safety cover 110 can be deformed, the safety cover 110 has a protruding tension, thereby providing a force against the deformation of the safety cover 110 (refer to FIG. 7). As a result, it is possible to suppress the displacement amount of the safety cover 110 at the low pressure when the battery is not abnormal (refer to the displacement amount before interruption in FIG. 5). From the above, the present disclosure can avoid occurrence of so-called unintended current interruption.

On the other hand, as described above, the total length in the predetermined width region of the safety cover 110 can be made large as compared with the case where the inclined portion 115 is not provided, and thus the displacement amount of the safety cover 110 for maintaining the current interruption can be made large due to the increased battery internal pressure that can occur at the time of battery abnormality (refer to the displacement amount after the interruption in FIG. 5). As a result, contact between the safety cover 110 and the stripper disk 130 can be avoided after current interruption at the time of battery abnormality. From the above, the present disclosure can avoid reconduction of the current.

The “displacement amount of safety cover 110” before and after the current interruption described above refers to a change amount from an initial position of central region 113 of safety cover 110 (a position before deformation of safety cover 110 when not affected by the battery internal pressure) to a predetermined position after deformation outward in the battery axial direction of safety cover 110.

In a preferred aspect, the angle between contact surface X1 on which safety cover 110 and top cover 150 described above are in contact and inclined portion 115 of safety cover 110 is 3 degrees or more and 10 degrees or less. Within such an angular range, it is possible to increase the amount of displacement of safety cover 110 for suppressing the amount of displacement of safety cover 110 under a low pressure when the battery abnormality is not occurring and for maintaining current interruption when the battery abnormality occurs.

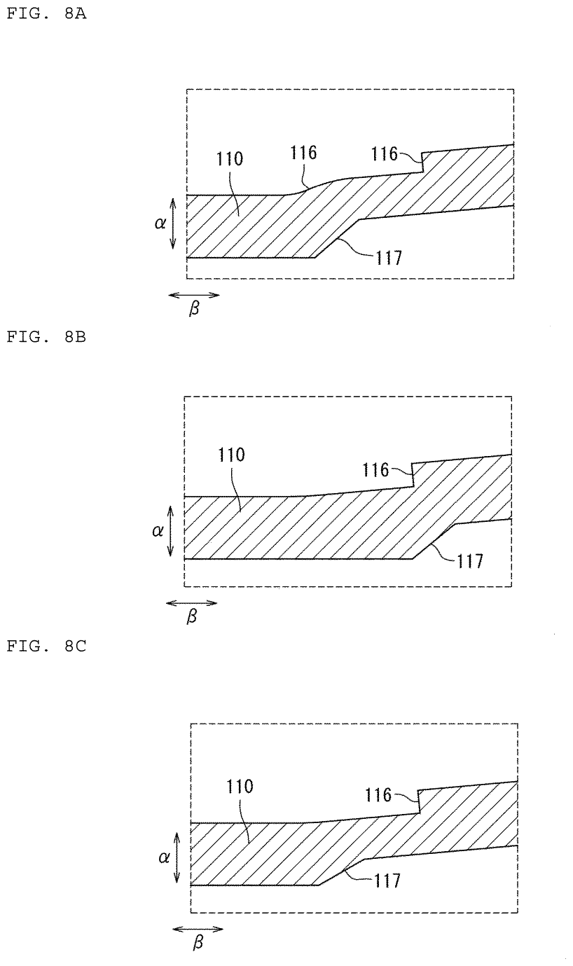

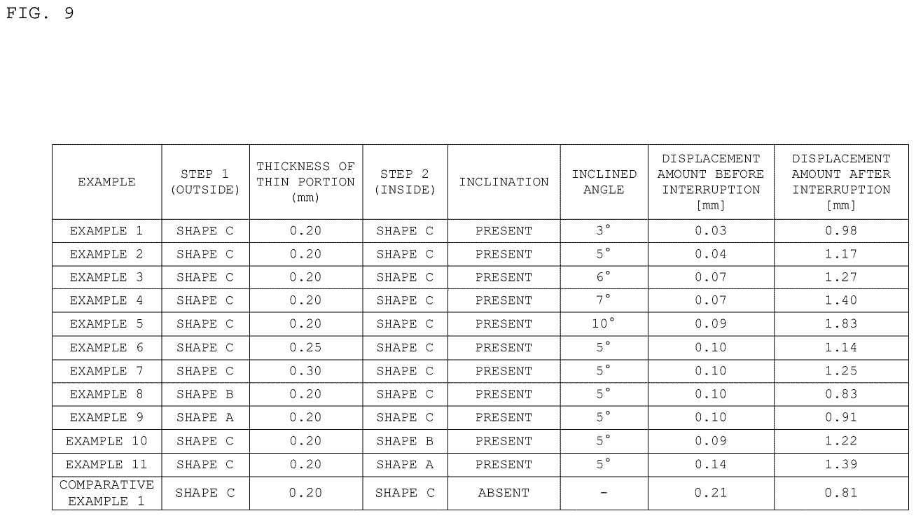

In addition, in a preferred aspect, at least one of first stepped portion 111 and second stepped portion 112 of safety cover 110 has a plurality of outer stepped surfaces 116 positioned outward in axis P direction of the battery and has one inner stepped surface 117 positioned inward in axis P direction (refer to FIG. 8A). Herein, as described above, the outward side in the battery axial direction refers to the side opposite to the side on which electrode assembly 10 is positioned with reference to the position of safety cover 110 in battery axis P direction. On the other hand, the inward side in the battery axial direction refers to the side opposite to the side on which safety cover 110 is positioned with reference to the position of safety cover 110 in the battery axis P direction. With such a configuration, the number of outer stepped surfaces 116 is plural, and thus the surface area of first stepped portion 111 and second stepped portion 112 can be increased.

When the battery is not abnormal, it is possible to increase the protruding force of safety cover 110, thereby increasing the force against the deformation of safety cover 110. As a result, it is possible to further suppress the displacement amount of safety cover 110 at the low pressure when the battery is not abnormal.

In addition, as compared with the case where inclined portion 115 is not provided, the total length in the predetermined width region of safety cover 110 can be made large, and in addition, the surface area in first stepped portion 111 and second stepped portion 112 can be made large, and thus the displacement amount of safety cover 110 for maintaining the current interruption can be made larger due to the increased battery internal pressure that can occur at the time of battery abnormality. As a result, contact between safety cover 110 and stripper disk 130 is further avoided after current interruption at the time of battery abnormality, and reconduction of the current can be further avoided.

In view of the above points, it is more preferable that both first stepped portion 111 and second stepped portion 112 of safety cover 110 have a plurality of outer stepped surfaces 116 described above and one inner stepped surface 117.

Without being limited thereto, if at least one of first stepped portion 111 and second stepped portion 112 of safety cover 110 has the configuration shown in FIG. 8A, the other can have the configuration shown in FIG. 8B or FIG. 8C.

Specifically, in the configuration shown in FIG. 8B, the other of first stepped portion 111 and second stepped portion 112 has one of outer stepped surface 116 and inner stepped surface 117, and the outer stepped surface 116 and the inner stepped surface 117 overlap each other in thickness direction α of safety cover 110. In addition, in the configuration shown in FIG. 8C, the other of first stepped portion 111 and second stepped portion 112 has one of outer stepped surface 116 and inner stepped surface 117, and the outer stepped surface 116 and the inner stepped surface 117 are provided to be shifted in radial direction β of the safety cover.

As for first stepped portion 111, it is preferable to displace safety cover 110 in one step between before and after the current interruption as indicated by a continuous solid line shown in FIG. 5. In this regard, in the configuration shown in FIGS. 8A and 8C, the surface of the safety cover 110 can include a relatively large number of horizontal portions 119 as compared with the configuration shown in FIG. 8B, and thus it is easy to achieve the one-step displacement of the safety cover 110. The horizontal portion 119 herein refers to a substantially flat region (not limited to a fully flat region) positioned between the outer stepped surface 116 and the inner stepped surface 117 in the radial direction β of the safety cover and extending in the radial direction. The displacement of the safety cover in one step herein refers to displacement from a state before interruption to a state after interruption without undergoing two-step behavior at a predetermined pressure. Taking such a one-step behavior, the first stepped portion 111 is displaced earlier than the first groove 118, and the displacement amount of the safety cover 110 before interruption to after interruption can be further increased. Thus, the contact between the safety cover 110 and the stripper disk 130 is more suitably avoided after current interruption at the time of battery abnormality, and reconduction of the current can be more suitably avoided.

In addition, in a preferred aspect, at least the first stepped portion 111 may have the thin portion 111a (refer to FIG. 4), and the ratio of the thickness of the thin portion 111a to the thickness of other portions of the safety cover 110 other than the stepped portions 111 and 112 may be 50% or more and 80% or less. At less than 50%, molding becomes difficult, and at more than 80%, desired displacement may be difficult to achieve. In this case, the first stepped portion 111 can take the behavior of the displacement curve of the safety cover 110 in one step between before and after the current interruption as indicated by a continuous solid line shown in FIG. 5.

The stepped portion, the thin portion, and the groove (that is, the first groove) provided in the safety cover and the groove (that is, the second groove) provided in the stripper disk according to the present disclosure can be provided at the time of press molding of each of the safety cover and the stripper disk. In addition, the element can be formed not only by press molding but also by other methods such as mechanical grinding and laser processing.

Although the embodiments of the present disclosure have been described above, the embodiments of the present disclosure described above are merely exemplary. Therefore, the present disclosure is not limited to these embodiments, and those skilled in the art will readily understand that various aspects can be conceived.

The present disclosure, in an embodiment, relates to providing a safety valve having an unprecedented configuration, and the cylindrical battery of the present disclosure has the following aspects.

Hereinafter, the present disclosure will be described using Examples according to an embodiment. The present disclosure is not limited at all by the following Examples.

The present disclosure was verified using the following software which is general-purpose software widely used in various technical fields and has high reliability. Coupled analysis software, manufactured by ANSYS, inc.: Ansys Mechanical (model: 2023 R1)
Verification target: safety valve having static structure
Material condition of each component of safety valve
   Top cover (safety valve lid member): structural steel
   Safety cover (safety cover): aluminum alloy
   Stripper disk (stripper disk): aluminum alloy
   Insulating member: resin PBT (polybutylene terephthalate)
Pressure setting: 0.1 MPa/s
Pressure for evaluating displacement amount: 10 MPa
First stepped portion 111: structures shown in FIG. 8A (corresponding to shape C in table), FIG. 8B (corresponding to shape B in table), and FIG. 8C (corresponding to shape B in table).
Second stepped portion 112: structures shown in FIG. 8A (corresponding to shape C in table), FIG. 8B (corresponding to shape B in table), and FIG. 8C (corresponding to shape B in table)

### Examples 1 to 11

Basic configuration: a safety valve (refer to FIG. 4) including a safety cover 110 disposed outward in the battery axial direction and having an inclined portion 115, a stripper disk 130 disposed inward in the battery axial direction, and an insulating member 120 disposed between the safety cover 110 and the stripper disk 130.

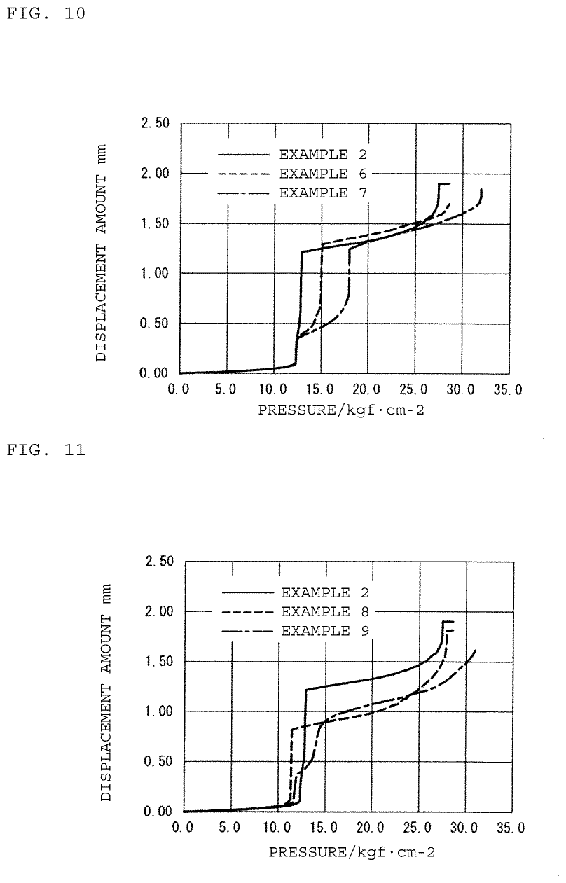

The step 1 in FIG. 9 corresponds to the first stepped portion 111, and the step 2 corresponds to the second stepped portion 112.

In each Example, as shown in FIG. 9, the shapes of the two stepped portions were appropriately selected, and the inclination angle was controlled to be changed in a range of 3 degrees to 10 degrees.

In Examples 6 and 7, as compared with other Examples 1 to 5 and 8 to 11, the thickness of the thin portion 111a in the first stepped portion 111 (corresponding to the step 1 in FIG. 9) of the safety cover 110 shown in FIG. 4 was set to 0.25 mm and 0.30 mm, respectively. In other Examples 1 to 5 and 8 to 11, the thickness of the thin portion 111a was set to 0.20 mm. Then, the relationship between the pressure on the safety cover 110 and the displacement amount of the safety cover 110 in Example 2, Example 6, and Example 7 (with a difference in the thin portion 111a) was confirmed (refer to FIG. 10).

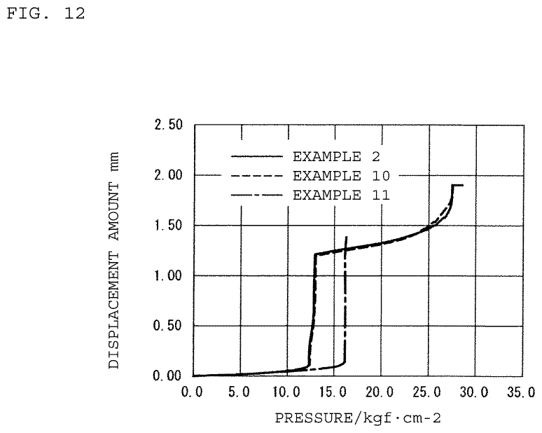

In addition, the relationship between the pressure on the safety cover 110 and the displacement amount of the safety cover 110 for the difference in the shape of the step 1 (corresponding to the first stepped portion 111) in FIG. 9 was confirmed (refer to FIG. 11).

Further, the relationship between the pressure on the safety cover 110 and the displacement amount of the safety cover 110 for the difference in the shape of the step 2 (corresponding to the second stepped portion 112) in FIG. 9 was confirmed (refer to FIG. 12).

### Comparative Example 1

As compared with the above Examples, the safety cover 110 having no inclined portion 115 was used.

As the evaluation, the displacement amount of the safety cover 110 before the current interruption and the displacement amount after the current interruption were measured.

### Results

The results are shown in FIGS. 9 to 12.

First, the following matters were found from the results of FIG. 9.
As compared with Comparative Example 1 (without inclined portion), it was found that the displacement amount before current interruption can be made less than 0.2 mm in Examples (with inclined portion).
As compared with Comparative Example 1 (without inclined portion), it has been found that the displacement amount after current interruption can be made 0.82 mm or more in Examples (with inclined portion).

From the above, it has been found that the amount of displacement of the safety cover 110 under the low pressure in a case of no battery abnormality can be suppressed as compared with Comparative Example 1 (without inclined portion). As a result, it has been found that occurrence of unintended current interruption can be avoided.

It has been found that the displacement amount of the safety cover 110 for maintaining current current interruption can be increased at the time of battery abnormality. As a result, it has been found that the contact between the safety cover 110 and the stripper disk 130 is avoided after current interruption at the time of battery abnormality, and the reconduction of the current can be avoided.

In addition, from the measurement result of FIG. 10, when the thickness of the thin portion 111a of the first stepped portion 111 (corresponding to the step 1 in FIG. 9) is 0.20 mm, the same thickness is 0.25 mm. It has been found that the displacement of the safety cover 110 in one step can be easily achieved as compared with the case of 0.30 mm.

From the measurement result of FIG. 11, it has been found that, when the shape of the first stepped portion 111 (corresponding to the step 1 in FIG. 9) is the configuration shown in FIGS. 8A and 8C (corresponding to shapes C and B in FIG. 9), the displacement of the safety cover 110 in one step can be easily achieved as compared with the configuration shown in FIG. 8B (corresponding to the shape A in FIG. 9).

From the measurement result of FIG. 12, it has been found that if displacement of the safety cover 110 in one step can be achieved when the shape of the second stepped portion 112 (corresponding to the step 2 in FIG. 9) is any of the configurations (corresponding to shapes C, A, and B in FIG. 9, respectively) shown in FIGS. 8A to 8C.

The effects and the like of the above-described Examples are merely one example. Therefore, the present disclosure is not limited thereto, and may have an additional effect.

The cylindrical battery of the present disclosure includes the following aspects according to an embodiment.

1

A cylindrical battery, including:
a top cover; and
a safety valve,
wherein the safety valve has a safety cover and a stripper disk positioned inward in the battery axial direction from the safety cover, and
a predetermined portion of the safety cover positioned between a portion where the safety cover and the top cover are in contact with each other and a portion where the safety cover and the stripper disk are in contact with each other is an inclined portion inclined inward in a battery axial direction with respect to a contact surface where the safety cover and the top cover are in contact with each other.
   2

The cylindrical battery according to <1>, wherein an angle between the contact surface and the inclined portion is 3 degrees or more and 10 degrees or less.

3

The cylindrical battery according to <1>or <2>, wherein the safety cover has a first stepped portion positioned on an outer peripheral side and a second stepped portion positioned on an inner peripheral side, and the first stepped portion and the second stepped portion are positioned between a portion where the safety cover and the top cover are in contact with each other and a portion where the safety cover and the stripper disk are in contact with each other.

4

The cylindrical battery according to <3>, wherein the inclined portion is portioned between the first stepped portion and the second stepped portion.

5

The cylindrical battery according to <3>or <4>, wherein at least one of the first stepped portion and the second stepped portion has a plurality of outer stepped surfaces positioned outward in the axial direction of the battery and has one inner stepped surface positioned inward in the axial direction.

6

The cylindrical battery according to <5>, wherein
one of the first stepped portion and the second stepped portion has the plurality of outer stepped surfaces and the one inner stepped surface, and
another of the first stepped portion and the second stepped portion has one each of the outer stepped surface and the inner stepped surface, and the outer stepped surface and the inner stepped surface overlap each other in a thickness direction of the safety cover.
   7

The cylindrical battery according to <5>, wherein
one of the first stepped portion and the second stepped portion has the plurality of outer stepped surfaces and the one inner stepped surface, and
another of the first stepped portion and the second stepped portion has one each of the outer stepped surface and the inner stepped surface, and the outer stepped surface and the inner stepped surface are provided to be shifted in the radial direction of the safety cover.
   8

The cylindrical battery according to any one of <3>to <7>, wherein at least the first stepped portion has a thin portion, and a ratio of a thickness of the thin portion to a thickness of a portion other than the stepped portion of the safety cover is 50% or more and 80% or less.

The cylindrical battery (battery such as a primary battery or a secondary battery) according to the present disclosure can be typically used for applications in which use of electric energy is required according to an embodiment. The cylindrical battery of the present disclosure can be used in the fields of electricity, information, and communication in which electrical/electronic equipment and the like are used (for example, the fields of electrical/electronic equipment and mobile equipment including mobile phones, smartphones, notebook computers, digital cameras, activity meters, arm computers, electronic paper, wearable devices, and small electronic machines such as RFID tags, card type electronic money, and smartwatches), home and small industrial applications (for example, the fields of electric tools, golf carts, and home, nursing, and industrial robots), large industrial applications (for example, the fields of forklifts, elevators, and harbor cranes), transportation system fields (for example, the fields of hybrid vehicles, electric vehicles, buses, trains, power-assisted bicycles, electric two-wheeled vehicles), power system applications (for example, the fields of various types of power generation, road conditioners, smart grids, and household power storage systems), medical applications (the field of medical equipment such as earphone hearing aids), pharmaceutical applications (the fields of dosage management systems and the like), IoT fields, space and deep sea applications (for example, the fields of space probes and submersibles), and the like, as merely examples.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A cylindrical battery comprising:
a top cover; and
a safety valve,
wherein the safety valve has a safety cover and a stripper disk positioned inward in a battery axial direction from the safety cover, and
a predetermined portion of the safety cover positioned between a portion where the safety cover and the top cover are in contact with each other and a portion where the safety cover and the stripper disk are in contact with each other is an inclined portion inclined inward in a battery axial direction with respect to a contact surface where the safety cover and the top cover are in contact with each other.

2. The cylindrical battery according to claim 1, wherein an angle between the contact surface and the inclined portion is 3 degrees or more and 10 degrees or less.

3. The cylindrical battery according to claim 1, wherein the safety cover has a first stepped portion positioned on an outer peripheral side and a second stepped portion positioned on an inner peripheral side, and the first stepped portion and the second stepped portion are positioned between a portion where the safety cover and the top cover are in contact with each other and a portion where the safety cover and the stripper disk are in contact with each other.

4. The cylindrical battery according to claim 3, wherein the inclined portion is portioned between the first stepped portion and the second stepped portion.

5. The cylindrical battery according to claim 3, wherein at least one of the first stepped portion and the second stepped portion has a plurality of outer stepped surfaces positioned outward in an axial direction of the battery and has one inner stepped surface positioned inward in the axial direction.

6. The cylindrical battery according to claim 5, wherein
one of the first stepped portion and the second stepped portion has the plurality of outer stepped surfaces and the one inner stepped surface, and
another of the first stepped portion and the second stepped portion has one each of the outer stepped surface and the inner stepped surface, and the outer stepped surface and the inner stepped surface overlap each other in a thickness direction of the safety cover.

7. The cylindrical battery according to claim 5, wherein
one of the first stepped portion and the second stepped portion has the plurality of outer stepped surfaces and the one inner stepped surface, and
another of the first stepped portion and the second stepped portion has one each of the outer stepped surface and the inner stepped surface, and the outer stepped surface and the inner stepped surface are provided to be shifted in a radial direction of the safety cover.

8. The cylindrical battery according to claim 3, wherein at least the first stepped portion has a thin portion, and a ratio of a thickness of the thin portion to a thickness of a portion other than the stepped portion of the safety cover is 50% or more and 80% or less.
